(19) United States
(12) Patent Application Publication
(10) Pub. No.: US 2005/0015399 A1
(43) Pub. Date: Jan. 20, 2005

(54) Web-based analytical tool for collaborative fleet optimization

(76) Inventors: William Melo, Ladera Ranch, CA (US); David S. Yun, Irvine, CA (US); Manuel Ley, Rowland Heights, CA (US); Christopher T. Park, Irvine, CA (US); Daryl Dressel, Portola Hills, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/619,386

(22) Filed: Jul. 14, 2003

(51) Int. Cl. G06F 7/00

(52) U.S. Cl. 707/102

(57) ABSTRACT

The present invention is directed to a system and method for optimizing collaborative fleet performance utilizing an Internet-based analytical tool. A user accesses the online tool via a secured access portal. The user is then prompted to provide current customer information, pricing and supplying terms, and customer objectives. The system then processes the information provided, prompting the user to select those products which most closely fulfill the customer's objectives. Once the necessary information has been input into the system, the web-based analytical tool generates a professional proposal suitable for presentation by the user to a prospective customer.

### BACKGROUND OF THE INVENTION

The present invention pertains generally to a method for optimizing office document production and, more particularly, to a method and system for a web-based analytical tool for collaborative fleet optimization.

Documents represent an essential and costly part of any business. Most organizations do not have a strategy to manage document production, storage and distribution. Documents have a lifecycle involving five distinct costs, creation, storage, retrieval, distribution and disposal.

Creation of the document involves work product, colors, collaborations, etc. Costs also accrue relating to the storage of documents in the form of hard copy and electronic document filing systems and records retention policies. Retrieval of documents raise expenses in document search and retrieval across a particular enterprise, including the security necessary to prevent unauthorized access. Distribution of documents also raise expenses for the output, shipping, inventory, waste and processing for both printed and not-for-print documents. Finally, the disposal of documents also costs an enterprise funds for the records retention and disposal policies, the effect of storage and disposal on regulatory compliance, liability and costs.

The cost of document management and output may account for as much as 9% of a company's yearly revenues. Of the total amount spent on document management and output, 75% are attributable to the document lifestyles. The infrastructure and support costs, e.g. information technologies, purchasing and administration, computers, printers, copiers, faxes, paper, toner, service, software, labor, shipping, servers, account for the remaining 25% of total costs attributable to document management and output. This represents a substantial portion of revenues that could rightly be put to other improvements in the enterprise's business. The number of pages an employee prints each year can range from 42,000 to 22,000. Even at the low end, 22,000 pages can cost a company almost $15,000 each year.

Thus, there exists a need for a method and system which minimizes the financial burden on document production and management while simultaneously improving the efficiency of the production and management of documents.

### SUMMARY OF THE INVENTION

The present invention provides for the analysis and optimization of document management and output. The invention is directed to a system and method for a web-based analytical tool capable of minimizing document production and management costs while increasing the overall productivity of a business.

More particularly, the present invention is directed to a web-based analytical application designed to help users gather and analyze customer fleet and/or business process data, configure and price a document imaging solution, and produce a professional proposal. The application analyzes customer's current and desired state, tailors a customer solution to achieve customer's goals, and installs, trains, and supports the customer. A custom product and solution configurations is created using fleet utilization information, document life cycle costs, strategic solutions. A rules-based product configuration module prevents errors and provides detailed pricing and profit/commission calculations.

In accordance with the present invention, there is provided a method for optimizing document management and output. The method begins with inputting select product information and product usage information. Once this information about a customer is entered, the method proceeds to retrieve information about the product and product usage from a database. The information from the customer and that retrieved from the database is analyzed to create a product configuration. The method then allows for the incorporation of the analysis, along with other prompted inputs, into a proposal based on the product configuration.

Further in accordance with the present invention, there is provided a web-based analytical system for collaborative fleet optimization. The system comprises means for inputting select product information and product usage information, usually via a computer network having access to the Internet. The system further comprises means for retrieving from a database communicatively coupled to the server on which the web-based analytical system resides product information and corresponding usage information from different office machine manufacturers. Accessed via typical database methods, the information is retrieved and compared with the customer information entered by the user. The means for analyzing this information generates a product configuration which meets the requirements from the customer's perspective. The system also includes means for generating a professional proposal based on the select information entered by the user, the information retrieved from the database and the objectives set forth by the customer.

Still further in accordance with the present invention, there is provided a computer program for analyzing and optimizing a collaborative fleet via the web. The computer readable medium of expression prompts the user to input customer specific information in predetermined fields. This information is then stored while information corresponding to the manufacturers' products is retrieved from a database. Both sets of information are then analyzed and prepared for entry into a proposal. The proposal is then compiled from the information received from the user and the information retrieved from the database.

Additional objects, advantages and novel features of the invention will be set forth in part in the description which follows, and in part will become apparent to those skilled in the art upon examination of the following or may be learned by practice of the invention. The objects and advantages of the invention may be realized and attained by various structures and methods as covered by the patent claims.

### BRIEF DESCRIPTION OF THE DRAWINGS

The accompanying figures incorporated in and forming a part of the specification, illustrates several aspects of the present invention, and together with the description serve to explain the principles of the invention. In the figures:

FIG. 1 is a screenshot of the online generator home page.

FIG. 2 is a screenshot of the online generator create new customer input page.

FIG. 3 is a screenshot of the online generator identify products input page.

FIG. 4 is a screenshot of the online generator product details input page.

FIG. 5 is a screenshot of the online generator configure input page.

FIG. 6 is a screenshot of the online generator quantity input page.

FIG. 7 is a screenshot of the online generator executive summary input page.

FIG. 8 is a screenshot of the online generator benefits summary input and selection page.

FIG. 9 is a screenshot of the online generator generate proposal page.

### DETAILED DESCRIPTION OF PREFERRED AND ALTERNATIVE EMBODIMENTS

The present invention is directed to a system and method for gathering and analyzing customer fleet and/or business process data, configuring and pricing a solution utilizing a user's products, and producing a highly professional proposal. The web-based analytical tool for collaborative fleet optimization is best exemplified by the attached figures. As used herein, the term fleet refers to those office machines, e.g. copiers, facsimile machines, printers, scanners, etc., used by a company or enterprise in the conduct of its normal business. The system utilizes a computer network, typically the Internet, to facilitate the communication between a user's computer and the server on which the analytical tool for fleet optimization resides. A user accesses the web-based tool via an existing secure portal. Communicatively coupled to the server is a database containing information on a multitude of different products, manufacturers, prices, performance standards and the like. The information contained in this database is used to compare user gathered customer product information with a base line sampling, allowing a comparison between the application's result and the customer's current products.

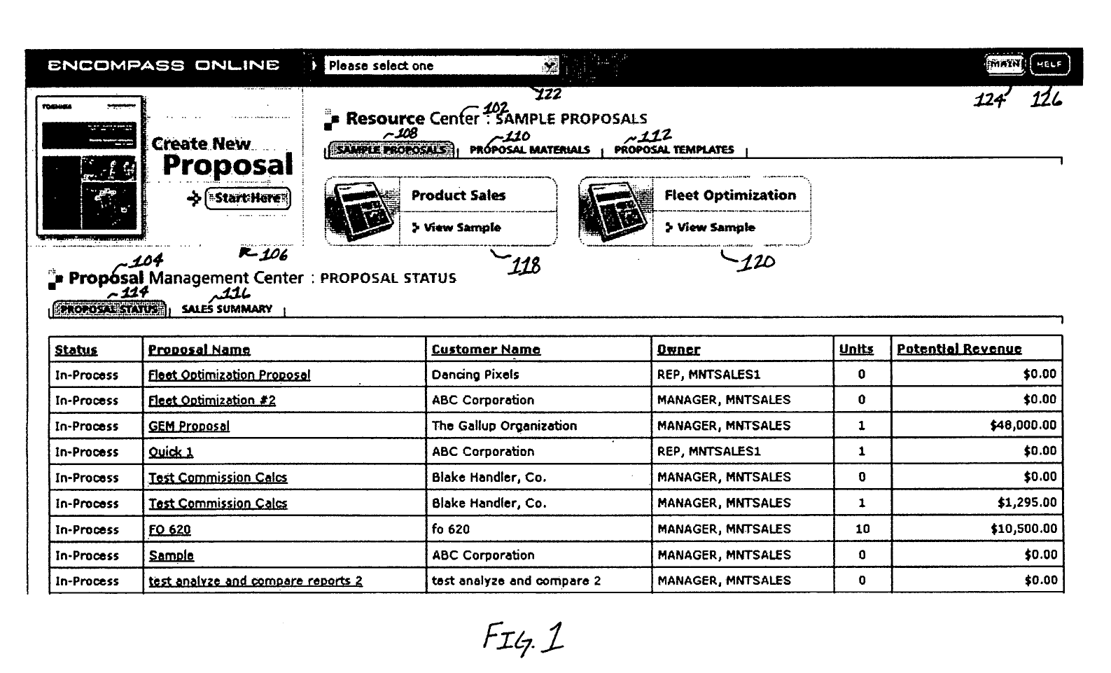

Turning to FIG. 1, there is presented a screenshot of the home page for the web-based tool. Auser first accesses this home page via the secured portal, requiring password authentication. Such authentication may be accomplished by any manner known in the art and is not the subject of the present invention. Upon entering the home page, the user is presented with a Resource Center 102, a Proposal Management Center 104, Create New Proposal link 106, a pull-down navigation menu 122, a return to main menu link 124 and a help link 126. The pull-down navigation menu 122 facilitates ease of movement throughout the entire site without having to utilize the graphical hyperlinks. The return to main menu link 124 will lead the user back to the site's home page, as shown in FIG. 1. The help link 126 will link the user to an online database of frequently asked questions, tips and other help topics. The Resource Center 102 contains links to Sample Proposals 108, Proposal Materials 110 and Proposal Templates 112. As a user chooses from among the three links, sub-links to examples are provided in the form of a Product Sales 118 sample proposal and a Fleet Optimization 120 sample proposal. The means for linking to different pages from another page are well known in the art and may be accomplished by any method utilized by those skilled in the art of web page programming.

The Proposal Management Center 104 contains links to two different categories for the user to view, Proposal Status 114 and Sales Summary 116. The first category, Proposal Status 114, provides data to the user in the form of a spreadsheet layout. This spreadsheet contains the status of each proposal, the proposal's name, the customer's name, the author of the proposal, the number of products contained in each proposal and the potential revenue attributable to each respective proposal. As shown in FIG. 1, the categories allow for a user to sort the spreadsheet according whichever category the user desires. The Sales Summary 116 spreadsheet (not shown) depicts the proposals, which resulted in sales to customers.

To utilize the web-based fleet optimization tool for generating a professional proposal, a user is presented with two options. First, a user may access the Proposal Templates 112 and edit these templates according to the customer's requirements. The second option is to use the Create New Proposal link 106 and generate a proposal without prior inputs in the form of a template.

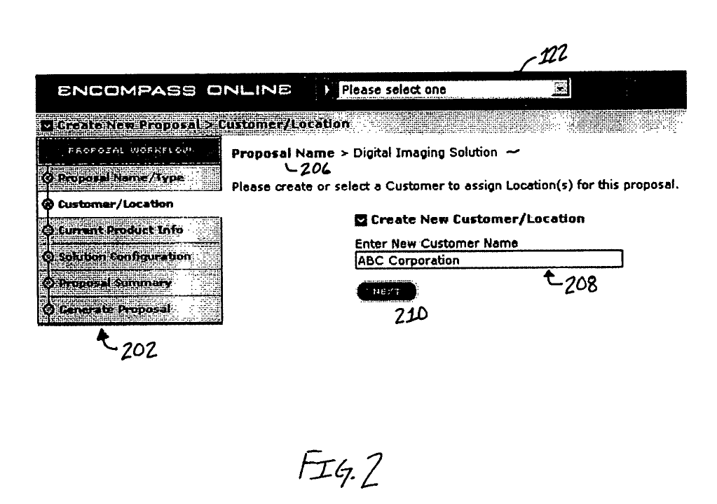

The user begins to utilize the web-based application by clicking on the Create New Proposal 106 graphical hyperlink. This prompts the user to enter a proposal name, as shown in FIG. 2 and designated as Proposal Name 206. The screen for entering the Proposal Name 206 is not shown. FIG. 2 is demonstrative of the user entering in either an existing customer name or creating a new customer name 208. As is shown in FIG. 2, the pull-down navigation menu 122, the return to main menu 124 and the help 126 links are all present on this page. Further, a Proposal Workflow Navigation Menu 202 is included, showing the different main topics to be incorporated into the proposal as well as providing means to move between different topics, particularly when a user returns to the site to complete an unfinished proposal. The user clicks the “Next” button to save the new customer name 208 and proceed to the next page.

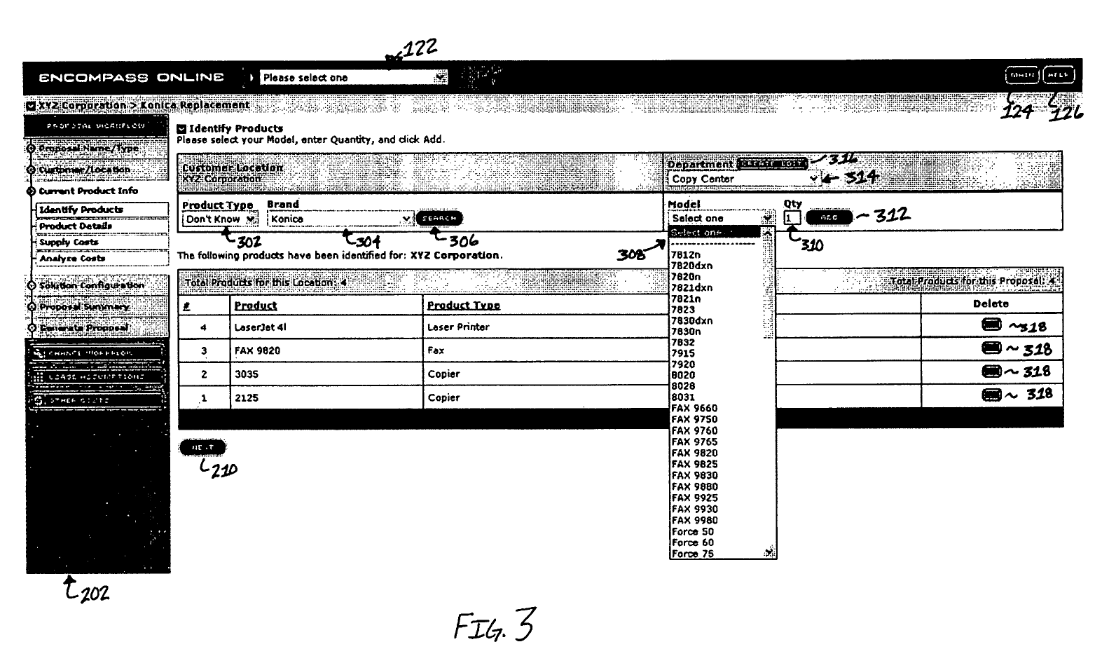

The user proceeds to the Current Product Information page, which contains links to four sub-pages, Identify Products, Product Details, Supply Costs, and Analyze Costs. FIG. 3 denotes the Identify Products sub-page. The Customer Location 320 shows the particular customer for which the user is preparing the proposal. Underneath the Customer Location 320, the user is prompted to select the Product Type 302 and the Brand 304. In the event that the user is unfamiliar with either the Product Type 302 or the Brand 304, the user may search through the lists stored on the web-site via the “Search” link 306. The user then selects the product model from the Model pull-down list 308 of models pertaining to the specific Brand 304 chosen above. The number of models are entered in Quantity 310 and the user is then queried as to the department in which the product is located. This is accomplished in the Department pull-down menu 314 or the user may create a new department by selecting the “Create/Edit” link 316. This allows the user to more accurately generate a customer specific analysis. The user then clicks the “Add” link 312 to incorporate the information into the customer's current product information. As shown in FIG. 3, the web-based tool presents the user with a spreadsheet incorporating the products identified using the process above.

The user is also presented with the ability to remove any products erroneously incorporated into the identified products. The user may click the “Delete” link 318 associated with each record contained in the spreadsheet. As in preceding pages, the user is able to return to the main menu via the return to main menu link 124, access help files via the help link 126, navigate via the pull-down 122 or the Proposal Workflow Navigation menu 202. To save the changes made to the products identified in FIG. 3, the user clicks the “Next” link 210 and proceeds to the next sub-page under Current Product Information.

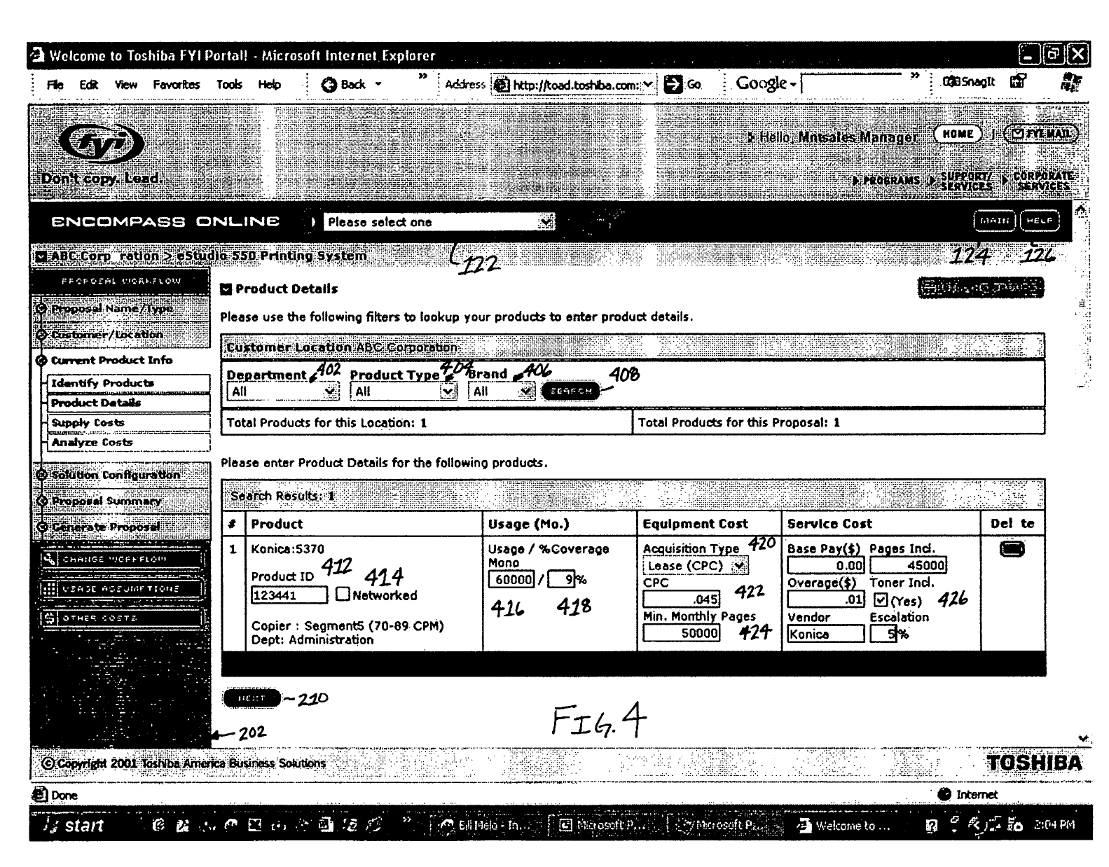

Having identified the products currently in use by the customer, the user must then enter the product details, as shown in FIG. 4. The Product Details page requires the user to input a multitude of information concerning the specific products previously identified. The screen prompts the user to utilize the Search feature 400 in locating the products to enter product details. The search may be conducted by selecting from Department 402, Product Type 404 or Brand 406 pull-down menus the specific product, or selecting all in each search parameter and clicking the “Search” link 408 to search for all products pertaining to a specific customer. As FIG. 4 shows, the search results 401 are displayed in tabular format, with text boxes requiring user input. The user is instructed to enter product details for Product ID 412, a check-box 414 for whether or not the product is networked, the Pages Used Per Month 416, the Percent Coverage 418, the Acquisition Type 420, e.g., lease, rent, purchase, the Cost Per Copy (“CPC”), the Minimum Monthly Pages 424, if applicable to the Acquisition Type, and the Service Costs 426. Upon completing the entry of all product details for each product shown in the search results 401, the user clicks the “Next” link 210 to save these details and progresses to the Supply Costs input page (not shown).

The Supply Costs may be either selected from a list of manufacturer suggested retail prices or custom entered by the user, depending upon the user's business practices. After completion of the Supply Costs, the web-based tool analyzes the costs associated with the customer for which the user seeks to generate a proposal. The application is then ready to proceed to configure a solution that optimizes performance while minimizing costs.

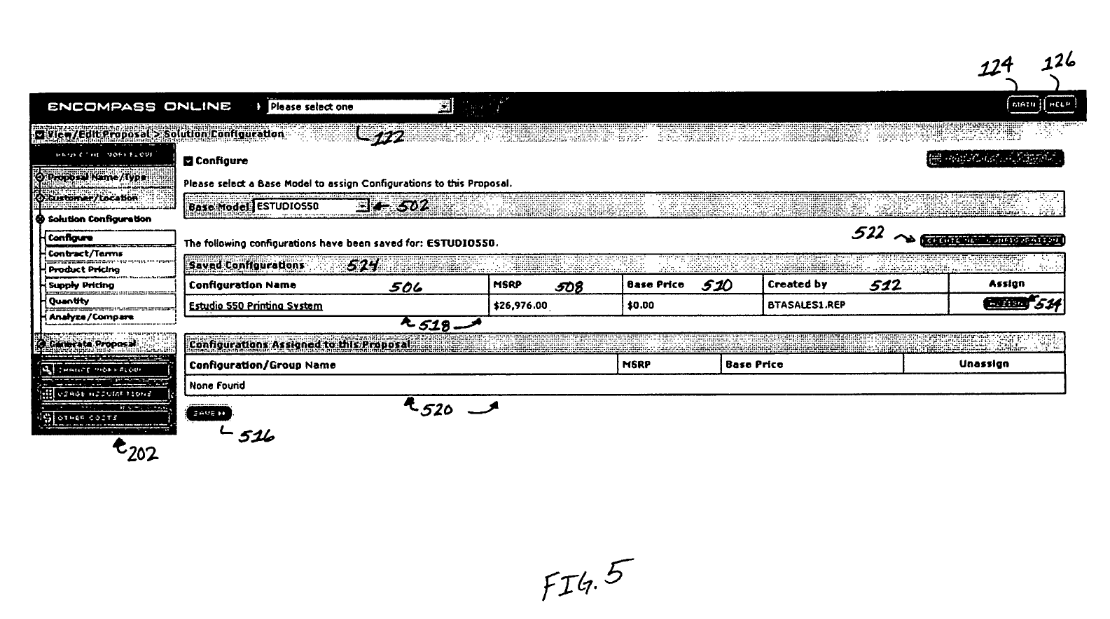

Turning to FIG. 5, there is shown the first step from the Solution Configuration page, the Configure sub-page. The user is prompted to select a Base Model 502 from the pull-down list of available models. The Base Model 502 represents the device which will be used as a replacement for the current products utilized by the customer. As shown in FIG. 5, the user selects the Base Model 502 from the list, resulting in a listing of Saved Configurations 524, if any have been saved corresponding to the particular Base Model 502. The user is able to either utilize those Saved Configurations 524 or click the “Create New Configuration” link 522 to create a new configuration built around the Base Model 502 selected. Configuration requires determining a Configuration Name 506, the Manufacturer's Suggested Retail Price (“MSRP”) 508, the Base Price 510 and the author 512. Once the Saved Configuration 524 is selected by the user, the user then clicks the “Assign” link 514 to assign the selected configuration to the proposal being generated. Upon assignment to the proposal, the Configurations Assigned to this Proposal 520 table denotes that a configuration has been incorporated into the proposal. The user then clicks the “Save” link 516 and the system progresses to the Contract/Terms page (not shown).

The user is then instructed to select the contract terms and conditions for the agreement being proposed. Navigation to the page containing contracts and terms may also be found via the Proposal Workflow Navigation menu 202 or the pull-down navigation menu 122. The terms and conditions may vary from user to user, and the user is provided with the ability to customize any term or condition to reflect customer requirements. The user is also able to customize any Product Pricing and any Supply Pricing consistent with the customer requirements.

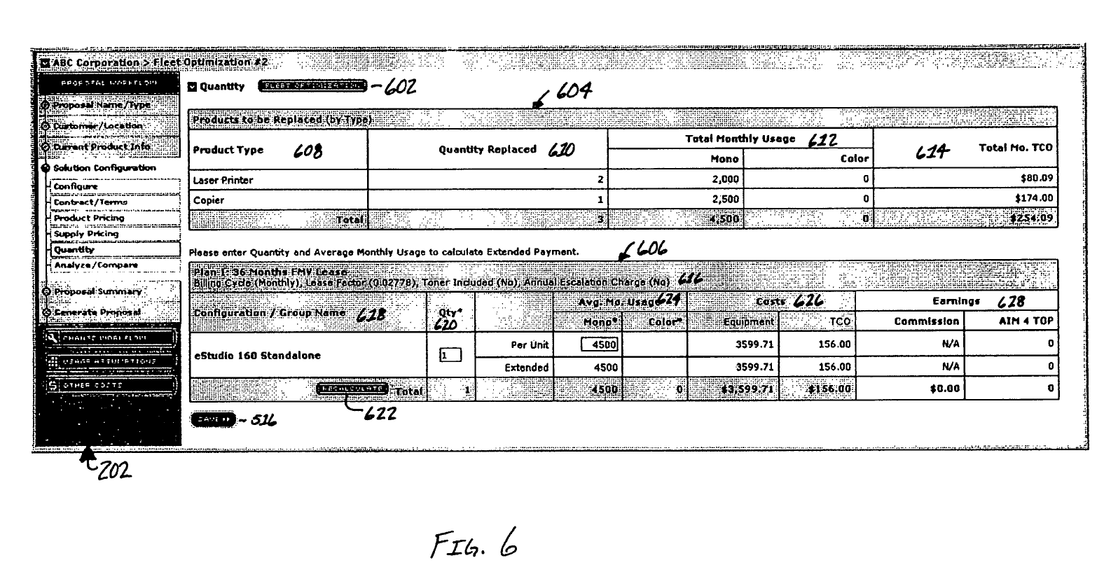

FIG. 6 is representative of the Quantity of products in the Solution Configuration. The user is provided with a table 604 showing the Product Type 608, the Quantity Replaced 610, the Total Monthly Usage 612, the Total Monthly Total Cost of Ownership (“TCO”) for the products being replaced. The Product Type 608 may be any of a fleet of different office machinery, including copiers, printers, faxes, etc., and will be displayed in the table 608. Each Product Type 608, regardless of the Quantity Replaced 610, will have a corresponding number of Pages Per Month 612, in either mono, color, or both printing. The user then is instructed to enter the Quantity 620 and the Average Monthly Usage 624 in order to calculate the Extended Payment option. The table 606 below the Products to be Replaced table 604, contains reference to the contract terms and conditions 616 selected, and requires user input as to the Quantity 620 and the Expected Usage 624. The costs 626 are automatically calculated as a result of the Product Pricing and Supply Pricing terms selected by the user. As the application may be used by users of varying levels in the distribution of products, Earnings 628 are calculated automatically as well, incorporating the Supply Pricing and Product Pricing previously set. The user is able to recalculate the totals by clicking “Recalculate” 622. Having set the quantity 620 and the Per Unit Average Monthly Usage 624, the system progresses to the Proposal Summary page.

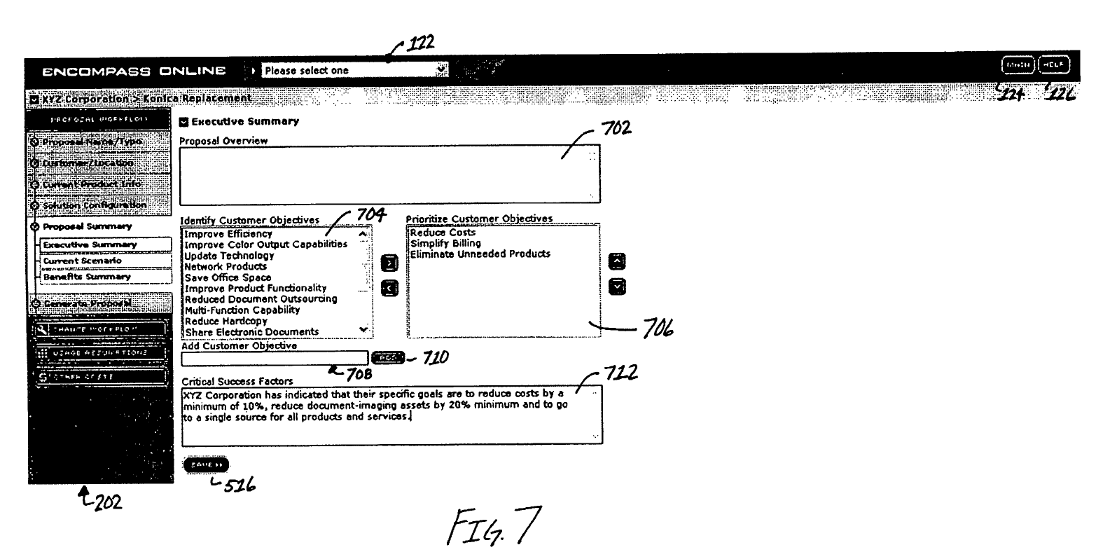

FIG. 7 denotes the first sub-page under Proposal Summary, the Executive Summary page. Located on this sub-page is a Proposal Overview 702 text box. This Proposal Overview 702 allows a user to briefly express a summary of the contents of the proposal. Once completed, the user then proceeds to list customer objectives. These customer objectives are listed in the Identify Customer Objectives list 704. The user may select from this list those objectives deemed high priority by dragging the customer objective from the Customer Objectives list 704 to the Prioritize Customer Objectives list 706. In the event that a customer objective expressed by the customer is not already included in the Customer Objectives list 704, the user may type in the Add Customer Objective box 708 that objective and click the “Add” link 710 to add that objective to the Customer Objective list 704. The user then drags the newly added objective to the Prioritize Customer Objectives list 706. A Critical Success Factors 712 text box is provided for the user to add those factors deemed critical to the customer. The user then clicks the “Save” link 516 and proceeds to the current scenario page (not shown).

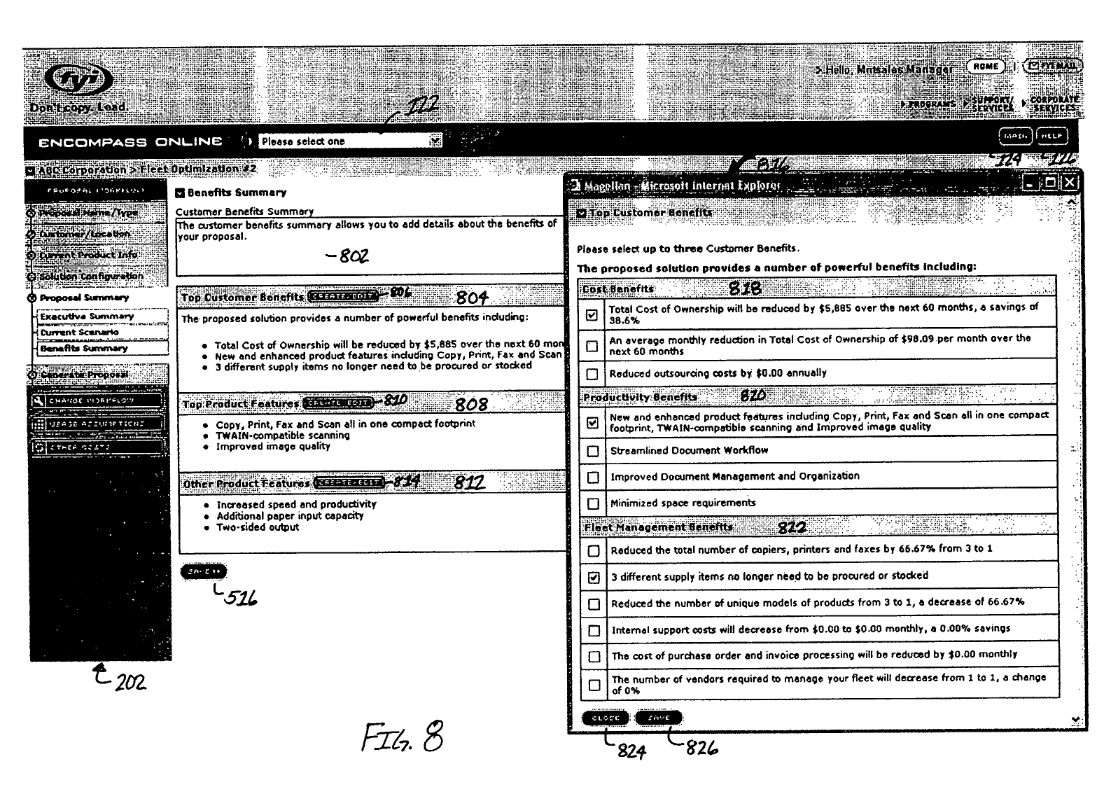

On the Current Scenario page, the entries made by the user on previous pages are displayed for review. Once reviewed, the user may proceed onward to the Benefits Summary page, as shown in FIG. 8. The Customer Benefits Summary 802 text box allows the user to add details about the benefits to the customer contained in the proposal. Once completed, the user reviews the Top Customer Benefits 804 list. In the event that the user is not satisfied with the items in the list, the user may click the “Create/Edit” link 806 to edit or add benefits. Execution of the “Create/Edit” link 806 gives rise to the Magellan window 816 depicted in FIG. 8. The Magellan window 816 prompts the user to select one benefit from each of three categories, Cost Benefits 818, Productivity Benefits 820 and Fleet Management Benefits 822. Selection of the three benefits is made by clicking the check-boxes located next to each listed benefit. Once three benefits have been selected, the user either saves the changes by clicking “Save” 826 or cancels the changes by clicking “Close” 824. The user then reviews the Top Product Features 808 and determines if the listed benefits are acceptable. In the event that the benefits are unacceptable, the user may click the “Create/Edit” link 810, which prompts a second Magellan window (not shown) to open. The user then must select one benefit from each of the three categories described above. Next, the user proceeds to Other Product Features 812 for review and acceptance. In the event that the benefits listed under Other Product Features 812 are unacceptable, the user may click the “Create/Edit” link 814 to open a third Magellan window. Once opened, the user selects one from each of the three categories previously described. It should be noted that the use of the Magellan window is for exemplary purposes only and one skilled in the art will recognize that other forms of data extraction and analysis generators may be used.

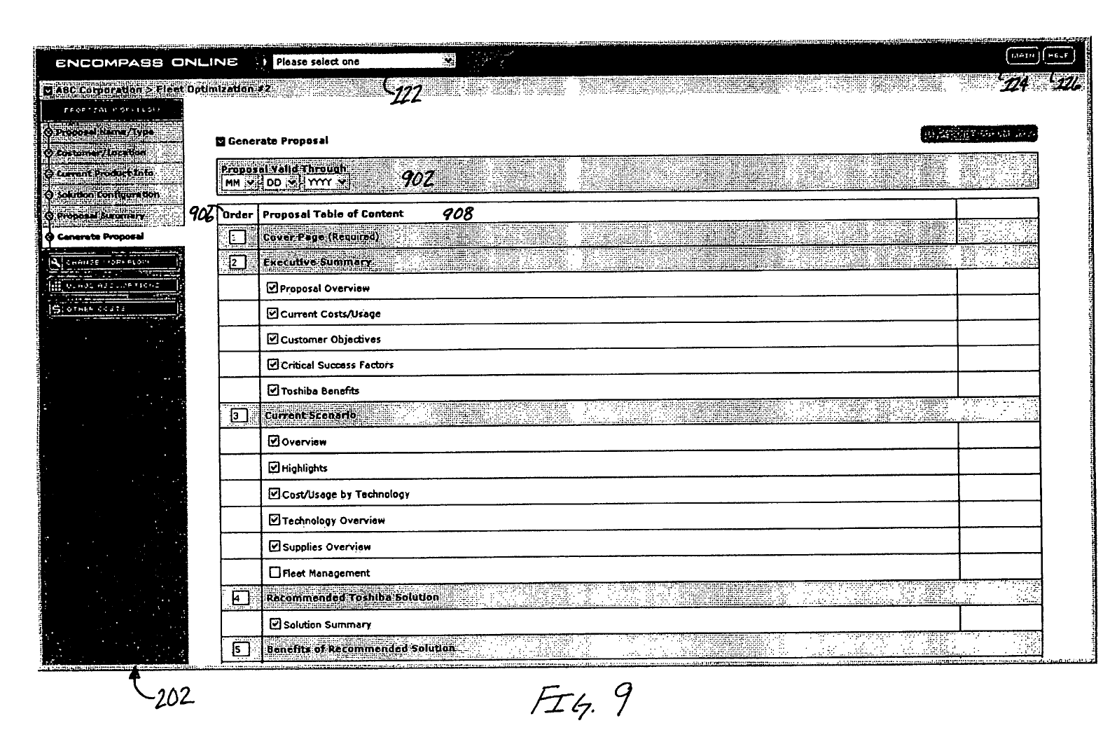

Upon satisfactory review of the Benefits Summary, the user saves the benefits by clicking “Save” 516. The user is then ready to finalize the proposal and proceeds to the Generate Proposal page, as shown in FIG. 9. The user is prompted to select a Proposal Valid Through date 902. This date allows the user to set a limit on the amount of time in which a customer has to review the proposal and accept its terms. As shown, a Proposal Table of Contents 908 is depicted in tabular format. The Order of pages 906 is displayed along the side of headings denoting the several pages described herein and the user is able to change the order of the proposal or deselect sections of the proposal the user does not desire to include. Having finalized the Order 906 and the Proposal Table of Contents 908, the user is then prompts the web-based application to save and print the professional proposal.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skilled in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

1. A method for optimizing document management and output, comprising the steps of:
inputting the at least one of selected product and usage information about at least one product;
retrieving selected information about at least one of selected product and usage information from a database;
analyzing the at least one of selected product and usage information and the at least one of the selected product and usage information from the database to create a desired product configuration; and
generating a proposal based on the desired product configuration.

2. The method of claim 1, wherein the at least one of selected product and usage information is one of the group consisting of a product detail, a product cost, a supply cost, a product type, and a product model.

3. The method of claim 1, further comprising selectively prompting the user to input information into predetermined fields.

4. The method of claim 1, wherein the inputting a proposal summary further comprises entering a benefits summary.

5. The method of claim 1, wherein the solution configuration comprises pricing information.

6. The method of claim 1, further comprising selecting customer objectives.

7. The method of claim 1, wherein the generating a proposal further comprises creating a table of contents.

8. The method of claim 1, further comprising the step of accessing a secured Internet web page.

9. A web-based analytical system for collaborative fleet optimization, comprising:
means adapted for inputting the at least one of selected product and usage information about at least one product;
means adapted for retrieving selected information about at least one of selected product and usage information from a database;
means adapted for analyzing the at least one of selected product and usage information and the at least one of the selected product and usage information from the database to create a desired product configuration; and
means adapted for generating a proposal based on the desired product configuration.

10. The system of claim 9, wherein the at least one of selected product and usage information is one of the group consisting of a product detail, a product cost, a supply cost, a product type, and a product model.

11. The system of claim 9, further comprising means adapted for creating customer objectives.

12. The system of claim 9, further comprising means adapted for creating a table of contents.

13. The system of claim 9, further comprising means adapted for accessing a secured Internet web page.

14. A computer program product having a computer readable medium having computer program logic recorded thereon for optimizing a collaborative fleet, comprising:
means adapted for inputting the at least one of selected product and usage information about at least one product;
means adapted for retrieving selected information about at least one of selected product and usage information from a database;
means adapted for analyzing the at least one of selected product and usage information and the at least one of the selected product and usage information from the database to create a desired product configuration; and
means adapted for generating a proposal based on the desired product configuration.

15. The computer program product of claim 14, wherein the at least one of selected product and usage information is one of the group consisting of a product detail, a product cost, a supply cost, a product type, and a product model.

16. The computer program product of claim 14, further comprising means adapted for creating customer objectives.

17. The computer program product of claim 14, further comprising means adapted for creating a table of contents.

18. The computer program product of claim 14, further comprising means adapted for accessing a secured Internet web page.
